(19) United States
(12) Patent Application Publication
(10) Pub. No.: US 2013/0211845 A1
(43) Pub. Date: Aug. 15, 2013

(54) METHOD AND DEVICE FOR PROCESSING VOCAL MESSAGES

(71) Applicant: LA VOCE.NET DI CIRO IMPARATO, (US)

(72) Inventor: Ciro IMPARATO, Torino (IT)

(73) Assignee: LA VOCE.NET DI CIRO IMPARATO, Torino (IT)

(21) Appl. No.: 13/749,579

(22) Filed: Jan. 24, 2013

(30) Foreign Application Priority Data
Jan. 24, 2012 (IT) TO2012A000054

(51) Int. Cl. G10L 13/033

(52) U.S. Cl. CPC G10L 13/033
USPC 704/278

(57) ABSTRACT

A method for automatically generating at least one voice message with the desired voice expression, starting from a prestored voice message, including assigning a vocal category to one word or to groups of words of the prestored message, computing, based on a vocal category/vocal parameter correlation table, a predetermined level of each one of the vocal parameters, emitting said voice message, with the vocal parameter levels computed for each word or group of words.

This application claims benefit of Serial No. TO 2012 A 000054, filed 24 Jan. 2012 in Italy and which application is incorporated herein by reference. To the extent appropriate, a claim of priority is made to the above disclosed application.

### BACKGROUND

The present invention relates to a method for emitting or decoding voice messages. In particular, the present invention relates to a method for emitting voice messages through an electronic emitting device adapted to automatically select at least one message among a plurality of expression modes. The present invention also relates to a method for decoding voice messages, which can be implemented by means of an electronic decoding device.

It is known that communication is based on three main rules: verbal, nonverbal and paraverbal communication. The first type determines the content of the message to be transmitted; the second type comprises facial expressions, and in general the body language being transmitted by the person communicating the message content; the third type of communication relates to the voice with which the message is being communicated.

Sometimes communicating may be difficult; even if the message content is clear, communication is easily subject to misunderstanding or misinterpretation.

Known studies have shown that only about 7% of every communication is based on the content of the message; approximately 55% is based on the nonverbal content thereof, while the remaining 38% is based on the voice with which the message is being perceived. Therefore, it is as if there were another language, i.e. voice, which needs to be tuned to words for the message to be perceived correctly.

Voice substantially has four parameters:
volume,
tone,
time,
rhythm.

Volume is defined as the sound intensity at which the message is being emitted.

Tone is the set of notes being given to each syllable of the message.

Time is the speed at which the syllables of the message are being pronounced.

Rhythm is the set of pauses inserted into the message between one word and the next.

The Applicant has perceived that, by appropriately mixing these four parameters, it is possible to send a voice message having the desired vocal expression.

In addition, the Applicant has also found it possible to use such parameters detected in a voice message being listened to in order to decode the emotions of the person who recorded the voice message.

Depending on the value of each one of the above-mentioned parameters, different typologies of voices can be perceived for each word, e.g. chosen among the following six vocal categories:
friendship,
trust,
confidence,
passion,
apathy, and
anger.

When listening to a message, therefore, it is possible to assign to each word being perceived, depending on the value of each vocal parameter (volume, tone, time, rhythm), a vocal category. Subsequently, depending on the consequentiality of the categories contained in the whole message, a plausible meaning can be associated therewith high or even very high probability.

For example, when a meaning must be associated with a sentence tapped during police investigations, the method becomes of great importance. For example, a sentence such as “come over here, I will settle you” may have radically opposite meanings, if the assigned vocal categories are different. In particular, if the words “come over here” belong to the passion category and the words “I will settle you” belong to the friendship category, then the meaning will be friendly or joking. On the contrary, if the words “come over here” belong to the confidence category and the words “I will settle you” belong to the anger category, then the meaning will certainly be threatening.

When creating a message, the sequences of the method according to the present invention are reversed; this means that, when creating a message, depending on the meaning to be associated therewith, a vocal category is first assigned to words or groups of words, and each word or group of words is then spoken with the levels of volume, tone, time and rhythm corresponding to the desired vocal category.

For this purpose, the present invention utilizes at least one vocal category/vocal parameter correlation table from which the correct vocal parameters to be assigned to each word or group of words are selected while creating the message; when a message is decoded, said table is used for assigning a vocal category to words or groups of words on the basis of the vocal parameters being detected.

### SUMMARY

The present invention may be applied to electronic devices for voice message generation, wherein it is possible, depending on the meaning to be given to each prestored message, to automatically emit said message through an electronic processing unit, while associating therewith different meanings by increasing or decreasing the level of each parameter. Let us now assume, for example, that such a method is used for creating automatic messages in public places, such as railway stations, airports, stadiums, etc., where normal service messages, information messages, warnings for delay situations, alarm messages, etc. may be sent. According to the contingent situation, an electronic device including a set of prestored messages, words or groups of words can emit the messages through suitable emitting means, such as loudspeakers, with different vocal categories depending on the most appropriate situation, which may be manually selected by an operator or be derived from information automatically received by the apparatus itself. Such automatically received information may be time information, e.g. the time elapsed since a previous similar warning message was emitted. In this case, the next message will have to be further emphasized, in accordance with an automatic procedure stored in the processing unit of the apparatus. Other information may be perceived by sensors of the apparatus, such as, for example, temperature or flame sensors, or other similar sensors adapted to detect dangerous situations requiring the transmission of alarm messages. Other examples of information affecting the vocal category of a message may be the time of day when the message must be emitted, in the case of a message to be repeated several times in a day. For example, at some hours of the day a different vocal category may be assigned to some words or groups of words.

The present invention is applicable to electronic devices for decoding voice messages, wherein a message being listened to can be analyzed and disassembled into words or groups of words, the vocal parameter level of which can then be read. Based on the above, an electronic processing unit of the apparatus may be able to associate a vocal category with such words and groups of words, and in general with the message as a whole, thereby returning the meaning thereof.

Depending on the industrial application of the present invention, a predetermined table can be built. For example, if the device for automatically generating a voice message has to be used for generating automatic warning messages in a very large environment, such as a railway station, then the table will contain different volume data than a table used for generating voice announcements to be listened to with headphones or in a small environment.

For the purposes of the present invention, it is possible to define levels of the above-mentioned vocal parameters in order to prepare an exemplifying correlation table. For example, the volume parameter may have five levels:
very low VL, (e.g. 20-35 db),
low L, (e.g. 35-50 db),
average A, (e.g. 50-65 db),
high H, (e.g. 65-80 db),
very high VH, (e.g. 80-90 db).

The tone parameter may have the same five levels:
very low VL, e.g. from fa0 to do2 for a man's voice and from do2 to do3 for a woman's voice,
low L, e.g. from la0 to mi2 for a man's voice and from mi2 to mi3 for a woman's voice,
average A, e.g. from re1 to la2 for a man's voice and from la2 to la3 for a woman's voice,
high H, e.g. from sol1 to re3 for a man's voice and from mi3 to mi4 for a woman's voice,
very high VH, e.g. from mi2 to do4 for a man's voice and from fa4 to do5 for a woman's voice.

The indications about the musical notes are those typical of a piano keyboard having, for example, 88 keys and a 7-octave extension.

The time parameter may have five levels:
very slow VS, e.g. 80-150 pronounced syllables/minute.
slow S, e.g. 150-220 pronounced syllables/minute.
average A, e.g. 220-290 pronounced syllables/minute.
fast F, e.g. 290-360 pronounced syllables/minute.
very fast VF, e.g. 360-400 pronounced syllables/minute.

The rhythm parameter can be defined by means of the duration of the pauses between one word and the next and the way in which the pause is introduced (sharp or elongated). The following levels can thus be defined:
sharp long pause PLN, e.g. a time longer than 1.2 sec, substantially in the absence of any sound,
sharp average pause PMN, e.g. a time of 0.4-1.2 sec, substantially in the absence of any sound,
sharp short pause PBN, e.g. a time shorter than 0.4 sec, substantially in the absence of any sound.
elongated long pause PLA, e.g. a time longer than 1.2 sec, substantially with a decreasing sound volume not higher than 20 db,
elongated average pause PLA, e.g. a time of 0.4-1.2 sec, substantially with a decreasing sound volume not higher than 20 db,
elongated short pause PLA, e.g. a time shorter than 0.4 sec, substantially with a decreasing sound volume not higher than 20 db.

In addition, the entrance (i.e. when sound approaches 0.5 db) next to the elongated pause will have a volume not lower than 15 db.

Based on the levels of the vocal parameters thus defined, the following vocal category/vocal parameter correlation table can be built by way of example.

| | Friendship | Trust | Confidence | Passion | Apathy | Anger |
|---|---|---|---|---|---|---|
| Volume | H | L | A | VH-H | A-L | VH |
| Tone | VH-A | L | H-L | VH-A | A-L | H |
| Time | F | S | A | VF-F | A-VS | F |
| Rhythm | PBN | PLA | PMN | PBN | PLA- | PBN |
| | | | | | PBA | |

A further parameter that may be advantageously used, although it has not been included in the table, is the so-called “voice smile”, which for the purposes of the present invention is defined as an indication of a voice's volume variations within a predetermined time period. For example, an apathetic voice will have no smile in it, and therefore this parameter will generally tend to be zero.

In brief, one aspect of the present invention relates to a method for treating voice signals, for the purpose of automatically generating a voice message having the desired vocal expression, which comprises the steps of:
assigning a vocal category to one word or to groups of words of the message,
computing, based on a vocal category/vocal parameter correlation table, the level of each one of the vocal parameters,
emitting said voice message, with the vocal parameter levels computed for each word or group of words.

According to a further aspect, the present invention relates to a method for automatically decoding a message being listened to, for the purpose of perceiving the vocal expression thereof and the emotion of the person who recorded the voice message, which comprises the steps of:
assigning a level of each one of the vocal parameters to each word or group of words of the message being listened to,
extracting, based on a vocal category/vocal parameter correlation table, the vocal categories of such words or groups of words starting from such vocal parameters assigned in the preceding step,
determining the vocal expression of said voice message, based on the analysis of such extracted vocal categories.

1. Method for automatically generating at least one voice message with the desired vocal expression, starting from a prestored voice message, comprising the steps of:
assigning a vocal category to one word or to groups of words of the prestored message,
computing, based on a vocal category/vocal parameter correlation table, a predetermined level of each one of the vocal parameters,
omitting said voice message, with the vocal parameter levels computed for each word or group of words.

2. The method according to claim 1, wherein such vocal categories are chosen among friendship, trust, confidence, passion, apathy and anger.

3. The method according to claim 1, wherein such vocal parameters are chosen among volume, tone, time, rhythm.

4. Method for automatically decoding a message being listened to, in order to detect its vocal expression and the emotion of the person who recorded the voice message, comprising the steps of:
assigning a level of each one of the vocal parameters to each word or group of words of the message being listened to,
extracting, based on a vocal category/vocal parameter correlation table, the vocal categories of such words or groups of words starting from such vocal parameters assigned in the preceding step,
determining the vocal expression of said voice message, based on the analysis of such extracted vocal categories.

5. The method according to claim 4, wherein such vocal categories are chosen among friendship, trust, confidence, passion, apathy and anger.

6. The method according to claim 5, wherein such vocal parameters are chosen among volume, tone, time, rhythm.

7. Electronic device for automatically generating a voice message with the desired vocal expression, starting from a prestored voice message, comprising:
storage means for storing such prestored messages and at least one vocal category/vocal parameter correlation table,
emitting means for emitting said voice messages,
an electronic processing unit for carrying out the steps of the method according to claim 1 and for controlling such storage and emitting means.

8. Electronic device for automatically decoding a message being listened to, in order to detect its vocal expression and the emotion of the person who recorded the voice message, comprising:
storage means for storing such prestored messages and at least one vocal category/vocal parameter correlation table,
means for detecting such messages being listened to, an electronic processing unit for carrying out the steps of the method according to claim 1 and to control such storage and detecting means.
